(19) United States
(12) Patent Application Publication
(10) Pub. No.: US 2026/0323226 A1
(43) Pub. Date: Oct. 15, 2026

(54) METHOD FOR NOISE SUPPRESSION IN A HEARING DEVICE AND HEARING DEVICE

(71) Applicant: Sivantos Pte. Ltd., Singapore (SG)

(72) Inventors: Tobias Daniel Rosenkranz, Erlangen (DE); Michael Müller, Erlangen (DE)

(21) Appl. No.: 19/174,204

(22) Filed: Apr. 9, 2025

(51) Int. Cl. H04R 25/00

(52) U.S. Cl. CPC H04R 25/507; H04R 25/305

(57) ABSTRACT

A method performs noise suppression in a hearing device. The method includes: deriving an intermediate audio signal from an input signal, dividing the intermediate audio signal into a first plurality of frequency bands, and applying a frequency band-specific noise reduction to the intermediate audio signal. The frequency band-specific noise reduction includes performing a first detection for determining a characteristic parameter related to a noise component and/or a useful signal component being present in respective signal contributions of the intermediate audio signal in the corresponding frequency band, and applying a frequency band-specific noise reduction gain to the signal contributions in the respective frequency band in dependence on the first detection. The method further includes applying a second detection to the intermediate audio signal for detecting speech present in the environment sound, and setting a value of some of the frequency band-specific noise reduction gains as a function of the speech detected.

### FIELD AND BACKGROUND OF THE INVENTION

The invention is related to a method for noise suppression of an audio signal in a hearing device. The hearing device contains at least one acousto-electric input transducer configured to generate an electric input signal, the audio signal being derived from the input signal. The invention further relates to a hearing device configured to perform the method for noise suppression.

Generally, a hearing device is an electronic device being configured to support the hearing of the person wearing it (which person is called the user or wearer of the hearing device). In particular, the invention relates to a hearing aid, i.e., a hearing device that is specifically configured to at least partially compensate a hearing impairment of a hearing-impaired user. Other types of hearing devices can be configured to support the hearing of normal hearing users, i.e., to improve speech perception in complex acoustic situations, or also communication devices. Furthermore, the term hearing device, as used herein, may relate to a device for streaming an audio signal such as speech or music, e.g. a headset, headphone, ear buds, etc.

Hearing devices in general, and hearing aids in particular, are usually configured to be worn on the head, and in this case in particular on the head or on one of the user's ears, especially as behind-the-ear devices (BTE devices) or in-the-ear devices (ITE devices). With respect to its internal structure, a hearing device normally contains an (acousto-electric) input transducer, a signal processor and an output transducer. During operation of the hearing device, the input transducer captures a sound signal from an environment of the hearing device and converts it into an input audio signal (i.e., an electric signal transporting a sound information).

In the signal processor, the captured sound signal (i.e., input audio signal) is processed, in particular amplified dependent on sound frequency, to support the hearing of the user, in particular to compensate a hearing-impairment of the user, to suppress ambient noise, etc. The signal processor outputs a processed audio signal (also called processed sound signal) to the output transducer. Most often, the output transducer is an electro-acoustic transducer (also called “receiver”) that converts the processed sound signal into a processed air-borne sound, which is emitted into the ear canal of the user. Alternatively, the output transducer may be an electro-mechanical transducer that converts the processed sound signal into a structure-borne sound (vibrations) that is transmitted, e.g., to the cranial bone of the user. Furthermore, besides classical hearing devices as described before, there are implanted hearing devices such as cochlear implants, and hearing devices the output transducers of which output the processed sound signal by directly stimulating the auditory nerve of the user.

One part of the aforementioned signal processing is often given by noise reduction, as environmental noise may compromise the ability of a hearing-impaired user to understand speech contributions. There are different strategies for such a noise reduction, all of which being typically a trade-off between signal processing resource needs (and thus, often also power consumption), attainable signal-to-noise ratio (SNR) and also an overall natural hearing experience, which may be compromised, e.g., by the possible generation of undesired artefacts in the processed signal or also by co-modulation of noise.

Such a co-modulation may occur when a broad-band noise reduction is released due to a detected presence of a desired “useful” signal component (typically speech), but the noise remains present in certain frequency bands without useful signal components. Fully band-specific noise reduction (and corresponding prior noise detection in each band), however, may lead to more complex algorithms, i.e., to higher power consumption. In general, the transition from the absence to the presence of a useful signal in certain bands is a challenging task to handle for noise reduction algorithms.

### SUMMARY OF THE INVENTION

The invention is based on the object of providing a method for noise suppression in a hearing device which shall be easy and resource-efficient to implement and at the same time shall allow for a realistic hearing experience. The invention is also based on the object of providing a corresponding hearing device.

According to the invention, the object is achieved in terms of the method by the features of the independent method claim, and in terms of the hearing device by the features of the independent hearing device claim. The dependent claims relate to advantageous embodiments and refinements. The advantages and embodiments mentioned regarding the method can be transferred expediently also to the hearing device, and vice versa.

With the foregoing and other objects in view there is provided, in accordance with the invention, a method for noise suppression in a hearing device, the hearing device containing at least one acousto-electric input transducer configured to generate an electric input signal from an environment sound. The method comprises the steps of: (a) deriving an intermediate audio signal from the input signal, (b) dividing the intermediate audio signal into a first plurality of frequency bands, (c) at least for some frequency bands, applying a frequency band-specific noise reduction to the intermediate audio signal, the frequency band-specific noise reduction containing (c1) the application of a first detection for determining a characteristic parameter related to a noise component and/or a useful signal component being present in respective signal contributions of the intermediate audio signal in the corresponding frequency band, and (c2) the application of a frequency band-specific noise reduction gain to signal contributions of the intermediate audio signal in the respective frequency band in dependence on the first detection.

The method further includes the steps of (d) applying a second detection to the intermediate audio signal, the second detection being configured to detect speech being present in the environment sound, and the second detection having a lower frequency resolution than the first plurality of frequency bands, and (e) setting a value of at least some of the frequency band-specific noise reduction gains also as a function of a speech detected in the second detection.

Furthermore, the invention provides a hearing device, containing at least one input transducer and at least one signal processing unit. The input transducer is configured to generate an electric input signal from an environment sound, and the signal processing unit is configured to perform the aforementioned method.

As indicated above, the notion of a hearing device may generally include any device which is configured to generate an output sound signal from an electrical signal, which in turn is derived from an electric input signal generated by means of a corresponding input transducer, and to feed the output sound signal to the hearing of a wearer (a user) of this device, i.e., in particular headphones (e.g., as an “earbud”), a headset, data glasses with loudspeakers, etc., being equipped with an input transducer as specified. However, a hearing device may also comprise a hearing aid in the “stricter” sense, i.e., a device configured for compensating, at least partially, a hearing impairment of the wearer, and in which the input signal generated from an environment sound signal by means of the input transducer is processed into an output signal and in particular amplified frequency band-wise in a user-specific manner and preferably in dependence on the audiological needs of the wearer. The output sound signal is then generated from the output signal by means of an output transducer (e.g., a loudspeaker or the like), and is suitable for the at least partial compensation of the hearing impairment of the wearer.

In recent times, solutions have been provided where parts of the above-mentioned signal processing are performed by an auxiliary device such as a smart phone or a smart watch specifically configured for an interaction with the aforementioned hearing device, forming a hearing system together. In the following, the term hearing device shall also comprise such a hearing system containing a head-worn unit (the “hearing device” in its stricter sense) and an auxiliary unit performing some of the signal processing.

The notion of an acousto-electrical input transducer in particular includes any device that is configured to generate an electrical signal from a sound signal. In particular, when the first input signal is generated by the input transducer, there may also be pre-processing, e.g. in the form of linear pre-amplification and/or A/D conversion. The input signal is in particular given by an electrical signal whose current fluctuations and/or voltage fluctuations essentially represent the sound pressure fluctuations of the air.

In order to perform the method, the hearing device in particular may be equipped with suitable signal processing means such as digital signal processors, volatile memory (RAM), hardwired circuits (ASICs) and the like. The entirety of these signal processing means shall be denoted as a signal processing unit, which may be implemented in one single integrated chipset, or may comprise various components.

The notion of deriving the intermediate audio signal from the input signal in particular comprises that signal components from the input signal enter into the intermediate audio signal, possibly with a frequency-dependent amplification and/or compression (or even clipping). This means that the input signal is not just a control signal on which some control value is measured for processing of the intermediate audio signal, but preferably, there exists a transfer function between the input signal and the intermediate audio signal. In particular, the intermediate signal may also be given as a beamformer signal. In this case, the hearing device also comprises at least another input transducer which generates another input signal from the environment sound, and the beamforming is performed on the two (or more) input signals. However, the derivation of the intermediate audio signal from the input signal may also be a “trivial” one, i.e., the intermediate audio signal is directly given by the input signal (in this case, the transfer function mentioned above is given by the identity).

The division of the intermediate audio signal into the first plurality of frequency bands is expediently performed by means of a filter bank. The filter bank may be implemented as a short-time discrete Fourier transform on the digital, i.e. discrete, intermediate audio signal. The frequency bands of the first plurality may have an equal bandwidth and spacing (e.g., of 200 Hz or 500 Hz for each band), or may have a narrower bandwidth and, thus, a higher frequency resolution for lower frequency bands; in particular, the bandwidth may increase, preferably, in a logarithmic way. In the case of an increasing bandwidth, the second detection preferably has a lower frequency resolution than the mean frequency resolution of the first plurality of frequency bands at least over the audible spectrum, and most preferably has a lower frequency resolution, i.e., a higher bandwidth, than the broadest frequency band of the first plurality.

At least in some frequency bands out of the first plurality, a frequency band-specific noise reduction is applied to the portion of the intermediate audio signal in the respective frequency band. Preferably, this noise reduction is applied for all frequency bands. However, it can also be useful to exclude certain frequency bands and in particular certain frequency ranges (possibly covering more than one frequency band) from this noise reduction, e.g., very high frequency bands, in order to save computational resources and also battery power.

For this frequency band-specific noise reduction, a first detection is applied to the signal portion of the intermediate audio signal in the respective frequency band, the first detection determining a characteristic parameter related to a noise component and/or a useful signal component in the signal contributions (i.e., in the signal portion) of the intermediate audio signal. The characteristic parameter may be given by a noise level and/or by a useful signal level, or may be a parameter derived from the noise level and/or useful signal level, or may be an indicator (possibly, a binary indicator) for the presence of stationary noise. In general, if noise is detected, then a noise reduction gain is applied to these signal contributions (i.e., to the signal portion) of the intermediate audio signal in the respective frequency band. Preferably, the noise reduction gain is determined gradually and dynamically on the basis of the characteristic parameter, i.e., the characteristic parameter not only indicates the presence of noise in the frequency band, but also controls the noise reduction gain in the respective frequency band, preferably in a monotonous way (e.g., in terms of SNR or another quantitative measure for the noise).

So far, an amount of noise that is determined in a frequency band will be reduced in the signal contributions of the frequency band by means of the corresponding noise reduction gain for this frequency band. However, typically such a frequency band-specific noise reduction gain should be limited to an attenuation of only a few dB, in order to avoid artefacts which may be annoying for the user. Yet, such an attenuation of a few dB may not be sufficient in certain situations (in particular, in very noisy environments during periods without any useful signal). But a stronger noise reduction is not desirable due to the mentioned possibility of artefacts.

To solve this problem, the method proposes to apply a second detection to the intermediate audio signal, wherein the second detection is configured to detect speech being present in the environment sound, i.e., to detect signal contributions from speech in the intermediate audio signal. The second detection has a lower frequency resolution than the first plurality of frequency bands, e.g., may either be given by a broadband detection or by a multiband detection with fewer (preferably significantly fewer) frequency bands than the first plurality of frequency bands in which the frequency band-specific noise reduction is applied. The second detection may detect speech contributions in the intermediate audio signal by any suitable means, e.g., by an artificial neural network (“ANN”) which is specifically trained for the purpose, or by detecting features indicative of speech such as characteristic modulations and/or characteristic concentrations of acoustic energy in certain frequency regions, or by a combination of both (e.g., by using these features as inputs to an ANN, instead of using the full intermediate audio signal as such an input to the ANN).

The second detection may detect speech in the intermediate audio signal in terms of a binary value, i.e., speech may be detected either to be “present” or “not present”. As an alternative, a “soft” probability value (i.e., any value from 0 to 1) for the presence of speech may be output as the result of the second detection. The specific implementation of the second detection may depend on the way its result is to be used, as it will be explained below.

As a next (and possibly final) step in the method, a value of at least some of the frequency band-specific noise reduction gains gnrk, which are determined on the basis of the noise detected in the respective frequency bands k by the first detection, is set also as a function of a speech detected in the second detection. This comprises in particular that at least some of the frequency band-specific noise reduction gains may be represented as mathematical functions of the two variables “characteristic value determined in the respective frequency band by the first detection” (variable x1) and “speech detected by the second detection” (variable x2), i.e., gnrk=F (x1, x2) for some function F of the variables x1 and x2. Note that the variable x1 is taken for each frequency band individually, while=x2 denotes the presence (or absence) of speech in a broader domain.

In case of the second detection being given by a broadband detection, x2 characterizes the overall speech presence in the (broadband) intermediate audio signal, and may be either a binary value (0 or 1) or a soft probability (from 0 to 1). In the alternative case of the second detection being given by a multiband detection with fewer frequency bands than the first plurality of frequency bands, i.e., a (smaller) second plurality of frequency bands, the detection of a presence (or an absence) of speech in a “higher order” frequency band of the second plurality is preferably used for setting noise reduction gains of those frequency bands of the first plurality which are comprised in the higher order frequency band (of the second plurality), or which at least have a non-negligible overlap with the higher order frequency band. Thus, x2 preferably characterizes only the speech presence in the higher order (second plurality) frequency band which comprises or at least significantly overlaps with the (first plurality) noise reduction frequency band of interest.

In particular, the function of speech detected in the second detection (and of noise being present in the corresponding frequency band) may be given by limiting the minimum value for the frequency band-specific noise reduction gain of each band, which may be dynamically and gradually dependent on the noise and/or useful signal related characteristic parameter determined by the first detection, in dependence on the speech detected by the second detection. As mentioned above, limiting the minimum of the noise reduction gain, i.e., “hard-clipping” the attenuation at a predetermined value, helps to prevent unwanted artefacts. Now, the value to which the minimum of the noise reduction gain (i.e., the maximum attenuation) shall be limited may be determined as a function of speech contributions being detected as “present” or “not present” in the intermediate audio signal by the second detection. Preferably, in a scenario without any speech, the minimum value for any noise reduction gain may be chosen lower (i.e., more attenuation) than for a case where speech is detected. In the latter case, the frequency band-wise noise reduction will typically not attenuate the signal contributions in the bands where speech is dominant (as it will typically not detect much noise there), but will attenuate the frequency bands in which noise is detected as dominant (and thus, speech is unlikely to be present). For a more natural hearing experience, it is useful to limit the noise reduction even in these noisy bands.

In an alternative implementation, the minimum value for the frequency band-specific noise reduction gains may be a continuous function of a soft probability for the presence of speech, the soft probability being determined by the second detection. In yet another alternative implementation, the above-mentioned function may be weighting the frequency band-specific noise reduction gains, determined from the first detection, by a factor dependent on the result of the second detection, e.g., on the soft probability for the presence of speech. These alternatives also allow for lowering the noise reduction gain in the frequency bands when the second detection does not detect any speech (or only with a very low probability), and for raising the noise reduction gain in a frequency band if speech is detected as present overall.

A major advantage of the present invention is that if speech is not detected by the second detection, i.e., is not present in the “broader” vicinity of a given frequency band, the noise reduction in this frequency band may be applied with more confidence. However, if speech is detected at least somewhere, then in several frequency bands, the frequency band-specific noise reduction will stop (or at least, will significantly decrease). Then, the method proposes to reduce the maximum attenuation also for the frequency bands which do have significant noise, in order to avoid artefacts and to provide a more realistic hearing experience.

Preferably, an output signal of the hearing device is derived from the intermediate audio signal after the proposed method for noise reduction has been applied, and the output signal is converted into an output sound signal by an electro-acoustic output transducer of the hearing device. Such an electro-acoustic output transducer is any device which is designed and configured to convert an electrical signal into a corresponding sound signal, whereby voltage and/or current fluctuations in the electrical signal are converted into corresponding amplitude fluctuations in the sound signal, i.e. in particular a loudspeaker, a so-called balanced metal case receiver, but also a bone conduction receiver.

When reading the claim language, the following definitions apply. When the claim language recites A and/or B it means A alone, B alone or A and B. When the claim language recites at least one of A and B it means A alone, B alone or A and B. When the claim language recites at least one of A or B it means A alone, B alone or A and B.

Other features which are considered as characteristic for the invention are set forth in the appended claims.

Although the invention is illustrated and described herein as embodied in a method for noise suppression in a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic and simplified illustration of a hearing device;

FIG. 2 is a schematic block diagram of a signal flow for a method according to the invention, to be performed by the hearing device of FIG. 1;

FIG. 3 is a graph showing a noise reduction gain gnr over a time t; and

FIG. 4 is a graph showing outputs of a first level meter and a second level meter in a given frequency band, plotted against time, while reacting to an impulse-like sound event starting at t=0 s (dashed line), after total silence.

### DETAILED DESCRIPTION OF THE INVENTION

Parts and variables which correspond to one another are always provided with the same reference signs in all the figures.

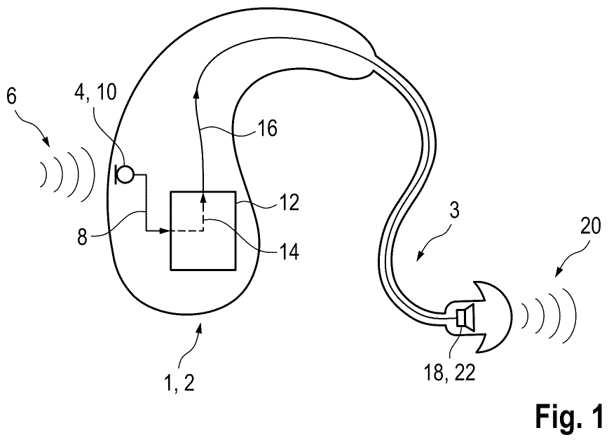

Referring now to the figures of the drawings in detail and first, particularly to FIG. 1 thereof, there is shown a schematic and simplified illustration of a hearing device 1. The hearing device 1 is given by a hearing aid 2 configured to compensate, at least partially, a hearing impairment of a hearing-impaired user. However, the invention is not restricted to hearing aids, and may be implemented by other hearing devices, such as communication devices or ear-bud type hearing devices configured to provide an additional assistance functionality to a user. The hearing aid 2 of FIG. 1 is shown here as a so-called Behind-The-Ear (BTE) type with an earpiece 3, but could be also given by an In-The-Ear (ITE) hearing device, a Receiver-In-the-Canal (RIC) device, a Completely-In-the-Canal (CIC) type device, or other suitable forms.

The hearing device 1 contains an acousto-electric input transducer 4 which is configured to convert an environment sound 6 into an electric input signal 8, wherein the air pressure fluctuations caused by the sound waves of the environment sound 6 are converted into corresponding voltage and/or current fluctuations of the input signal 8. The input transducer 4 in the embodiment shown in FIG. 1 is given by a microphone 10. The hearing device 1 may also comprise at least one further input transducer (not shown), generating a corresponding further input signal, for a directional processing of the generated input signals.

The hearing device 1 contains a signal processing unit 12, which in the present embodiment shall include all signal processing means of the hearing device 1, e.g., one or more signal processors, a RAM that is addressable via the signal processor(s), a non-volatile memory for storing signal processing algorithms and corresponding parameters, and possibly ASICs and/or other hard-wired circuitry. In the present embodiment of the hearing device 1 being given by the hearing aid 2, the non-volatile memory of the signal processing unit 12 also stores information on the audiological needs of the user, e.g., an audiogram and the like.

The input signal 8 is processed in the signal processing unit 12, thereby generating at least one intermediate audio signal 14, into an output signal 16, wherein the signal processing in particular may include frequency-dependent amplification and/or compression, as well as noise reduction. Preferably, the signal processing in the present case is being performed in dependence on the audiological needs of the user. However, in a more general case, the signal processing may also contain algorithms that are performed on the basis of general benchmarks (such as SNR improvement and the like).

The output signal 16 is fed to an electro-acoustic output transducer 18 located in the earpiece 3, the output transducer 18 being designed and configured to convert the output signal 16 into a corresponding output sound signal 20 which is presented to the hearing (i.e., to the tympanum or to the cranial bone near the ear) of the user. The output transducer 18 in the present case is shown as a loudspeaker 22, but could be given by a bone conduction receiver or another suitable sound generating apparatus.

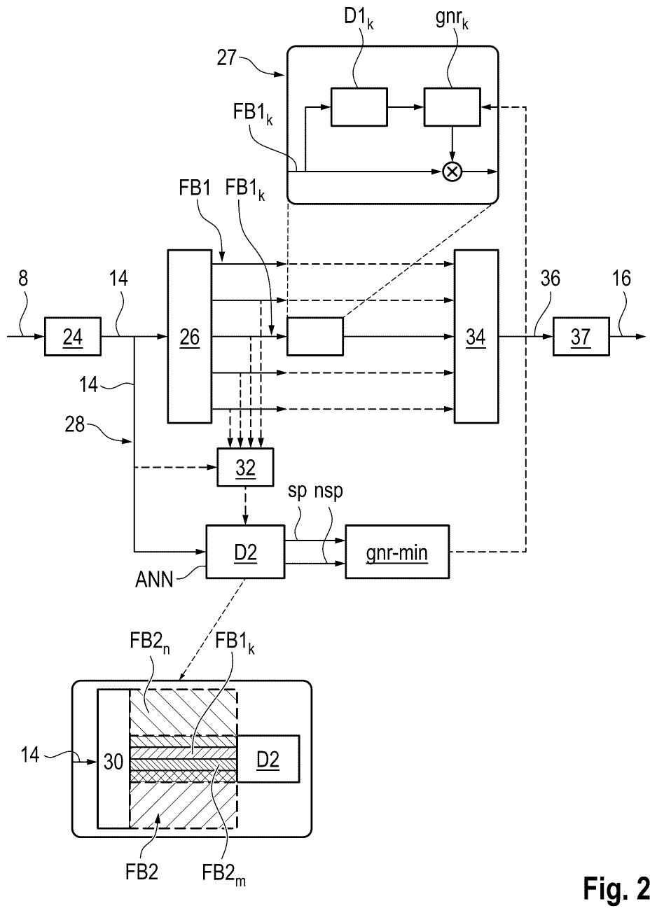

FIG. 2 shows a schematic block diagram of a signal flow for a noise reduction method according to the invention, to be performed by the hearing device 1 of FIG. 1, and in particular, by its signal processing unit 12, i.e., the entire signal flow shown in FIG. 2 may be performed in the signal processing unit 12.

The input signal 8 may be converted into an intermediate audio signal 14 by means of pre-processing 24 such as pre-amplification, an A/D-conversion, limiting or other types of equalizing, but also beamforming in the aforementioned case of two or more input signals. The intermediate audio signal 14 is divided into a first plurality of frequency bands FB1 by means of a first filter bank 26.

A frequency band-specific noise reduction 27 is applied to the signal portions of the intermediate audio signal 14 in each of the frequency bands FB1 of the first plurality. For reasons of clarity, this frequency band-specific noise reduction 27 is illustrated in more detail in the corresponding inset graphic only for the k-th frequency band FB1ₖ generated by the first filter bank 26. The signal flow for the remaining frequency bands FB1 of the first plurality 26, which may also feature such a frequency band-specific noise reduction 27 as indicated for the frequency band FB1ₖ, is indicated by dashed arrows.

For the frequency band-specific noise reduction, a first detection D1ₖ is applied to the signal portion of the intermediate audio signal 14 in the frequency band FB1ₖ. The first detection is designed and configured to determine a characteristic parameter related to a noise component and/or to a useful signal component in this signal contribution, in a way yet to be described below. This characteristic parameter may be a binary indicator whether noise is present in the frequency band FB1ₖ (e.g., whether the noise level exceeds a given threshold or whether a given proportion of the signal is given by noise). The characteristic parameter may also be given, e.g., by a noise level. In dependence on the characteristic parameter determined by the first detection D1ₖ for the frequency band FB1ₖ, a noise reduction gain gnrk is applied to the signal contributions in the frequency band FB1ₖ. The noise reduction gain gnrk for the frequency band FB1ₖ generally depends on the amount of noise detected by the first detection D1ₖ in this frequency band FB1ₖ, but is also other controlled based on other factors, as shall be outlined below.

In order to control this frequency band-specific noise reduction in the frequency bands FB1, the intermediate audio signal 14 is tapped of to an auxiliary signal path 28, a second detection D2 configured to detect the presence of speech is applied to the intermediate audio signal 14. This second detection has a lower, and preferably a significantly lower frequency resolution than the first plurality of frequency bands FB1. The second detection D2 may thus be performed on the broadband signal intermediate audio signal 14, i.e., the detection, even if there may be possibly employed certain information from individual frequency ranges (which, in turn, may be obtained from corresponding measurements in the frequency bands FB1 of the first plurality), the second detection is only capable for detecting the presence of speech in the whole intermediate audio signal 14.

In an alternative embodiment (see dashed arrow to inset graphic), the intermediate audio signal 14 is divided into a second plurality of frequency bands FB2, e.g., by means of a second filter bank 30, the second plurality being (significantly) smaller than the first plurality, and the second detection D2 detects speech being present in the environment sound to the respective signal contributions of the intermediate audio signal 14 in an m-th frequency band FB2ₘ of the second plurality. This means that the second detection D2 is configured to distinguish between the frequency bands FB2 regarding whether there is a significant amount of speech present, i.e., the second detection D2 may output the presence of speech for one “higher order” frequency band FB2ₘ while outputting an absence of speech for another “higher order” frequency band FB2ₙ. The corresponding inset graphic shows a possible relationship between the frequency bands FB1 of the first plurality (i.e., from the first filter bank 26) and the “higher order” frequency bands FB2 for the second detection D2 (i.e., from the second filter bank 30).

In an embodiment, the second detection D2 is performed by means of an artificial neural network ANN, and an output class of the artificial neural network is the presence of speech (sp). Preferably, another output class may be an absence of speech (nsp). Implementing the second detection D2 of the presence of speech by an ANN allows for a high-precision, low false-positive detection of speech even for the case of a very low frequency resolution or even in a broadband detection. Likewise, keeping the frequency band-specific noise reduction active in the individual frequency bands FB1 of the first plurality, but operating the noise reduction in dependence on the ANN-based speech detection ensures that a sufficiently high frequency resolution for noise reduction may be achieved without the need for implementing ANNs in a lot of frequency bands. Thus, computational hardware resources and battery consumption may be kept reasonably low.

Depending on the specific implementation of the second detection and on its resulting frequency resolution, the ANN may operate on the broadband intermediate audio signal 14, or on its signal contributions of the “higher order” frequency bands FB2. The ANN may be implemented as a program module by a signal processor of the signal processing unit 12, or via some hardwired ASIC contained in the signal processing unit 12.

In another advantageous embodiment, a plurality of acoustic features 32 are generated on the basis of the input signal 8, and preferably on the basis of the intermediate audio signal 14, and the acoustic features 32 are used as input values to the artificial neural network, wherein the acoustic features are chosen out of the following set: a spectral centroid of an overall signal and/or of a noise background, a modulation depth for at least one given modulation frequency, a signal stationarity, a signal level, a noise level for at least one given frequency range, an auto-correlation value for at least one given time delay. These acoustic features 32 may be easily obtained from the intermediate audio signal 14 (from the broadband signal or from the signal portions in the first plurality of frequency bands FB1) without the need of a detailed speech analysis in each frequency band FB1.

Now, for the frequency band-specific noise reduction in the individual frequency bands FB1, such as the k-th frequency band FB1ₖ, the frequency band-specific noise reduction gain gnrk is determined also in dependence on the result of the second detection D2, i.e., as a function of both the noise/useful signal related characteristic parameter determined in the individual frequency band FB1ₖ by the first detection D1ₖ and the presence of speech sp or the absence of speech nsp detected by the second detection D2 on the broadband intermediate audio signal 14 (or on the higher order frequency band FB2ₘ comprising the frequency band FB1ₖ).

In an embodiment, this in particular comprises setting a maximum value (not shown) and/or a minimum value gnr-min of the frequency band-specific noise reduction gains gnr as a function of the speech detected in the second detection D2. In particular, setting a minimum value of a noise reduction gain gnrk in a frequency band FB1ₖ allows for limiting the attenuation in dependence on the overall speech presence (i.e., the speech presence (sp) detected by the second detection D2 either in the broadband intermediate audio signal 14 or on the higher order frequency band FB2ₘ containing the frequency band FB1ₖ).

After the frequency band-specific noise reduction (i.e., the application of the frequency band-specific noise reduction gain gnrk to the signal components in the frequency band FB1ₖ), further frequency band-specific signal processing (not shown) may take place. The individual frequency bands FB1 of the first plurality are then combined by means of a synthesis filter bank 34 into a noise-reduced broadband signal 36, from which the output signal 16 is derived, either by applying further broadband signal processing 37 onto the noise-reduced broadband signal 36 (such as additional broadband amplification and/or compression), or by directly taking the noise-reduced broadband signal 36 as the output signal 16.

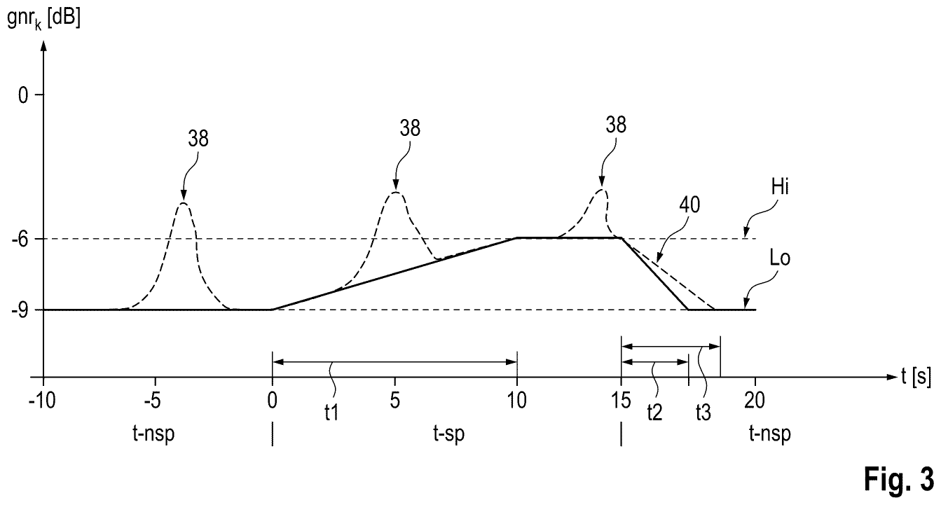

Setting the minimum value gnr-min as a function of the speech detected in the second detection D2, is shown schematically in FIG. 3 in a diagram of the noise reduction gain gnr over a time t. The minimum value gnr-min is depicted by a solid line. An actual noise reduction gain gnrk to be applied to the signal contributions in the k-th frequency band is depicted by a dashed line (where deviating from the minimum value gnr-min).

In a particular embodiment, the minimum value gnr-min of the frequency band-specific noise reduction gains gnr are set to a low value Lo for no speech (nsp) being detected by the second detection D2 (c.f. FIG. 2), and/or the minimum value gnr-min of the frequency band-specific noise reduction gains gnr to a high value Hi for speech being detected as present (sp) by the second detection D2. Setting the minimum value gnr-min for a frequency band-specific noise reduction gain gnrk to a low value Lo if no speech is detected in a broader environment of the frequency band FB1ₖ allows for a more effective noise reduction, while setting this minimum value gnr-min to a higher value Hi if the presence of speech is detected in a broader environment of the frequency band FB1ₖ helps to prevent unwanted artefacts. Preferably, the low value Lo for the minimum noise reduction gain gnr-min is chosen out of the interval [−12 dB, −5 dB], and/or the high value Hi is chosen out of the interval [−8 dB, −3 dB]. Preferably, the low value Lo and the high value Hi are chosen to have a difference of at least 1 dB and most preferably at least 2 dB. In the embodiment example shown in FIG. 3, the low value is chosen to be −9 dB, while the high value Hi is chosen to be −6 dB. In case that the first detection D1ₖ is configured to detect a presence of noise in the frequency band FB1ₖ that requires an attenuation, the signal components therein are attenuated at most by an amount corresponding to |gnr-min|. The signal components may be attenuated by a lesser amount, if only moderate amounts of stationary noise are detected. This is shown for the attenuation relief bumps 38.

Preferably, upon the second detection D2 detecting the presence of speech (at t=0 s in FIG. 3) after a phase of no speech (nsp), the minimum value gnr-min is faded with a first time constant t1 from the low value Lo to the high value Hi. This means in particular that when the second detection D2, after a time period t-nsp without detecting speech, starts to detect the presence of speech (sp), the minimum value gnr-min for a frequency band-specific noise reduction gain gnr (preferably, for all frequency bands FB1) is increased slowly from the low value Lo to the high value Hi, wherein the increase may be of linear, logarithmic, exponential, sigmoidal or of any other smooth monotonous shape. Preferably, the first time constant t1 is chosen out of the interval [5 s, 15 s], and most preferably [6 s, 12 s]. In the embodiment example shown in FIG. 3, the first time constant t1 is chosen to be 10 s. In particular, after the time corresponding to the first time constant t1 has elapsed, the minimum value gnr-min for the noise reduction gain gnr has attained the high value Hi.

Expediently, upon the second detection D2 detecting no speech (in FIG. 3 at t=15 s) after a phase (t-sp) of speech being present (sp), the minimum value gnr-min is faded with a second time constant t2, the second time constant t2 preferably being smaller than the first time constant t1, from the high value Hi to the low value Lo. This means in particular that when the second detection D2, after a time period (t-sp) of detecting the presence of speech (sp), ceases to detect the presence of speech (nsp), the minimum value gnr-min for a frequency band-specific noise reduction gain gnr (preferably, for all frequency bands FB1) is decreased from the high value Hi to the low value Lo, wherein the decrease may be of linear, logarithmic, exponential, sigmoidal or of any other smooth monotonous shape. Preferably, the second time constant t2 is chosen out of the interval [1 s, 5 s]. In the embodiment example shown in FIG. 3, the second time constant t2 is chosen to be 3 s (starting at t=15 s). In particular, after the time corresponding to the second time constant t2 has elapsed, the minimum value gnr-min for the noise reduction gain gnr has attained the low value Lo.

In an embodiment, the method further contains applying, upon the second detection D2 detecting no speech (nsp) being present in the environment sound, a multi-band noise reduction 40 to the intermediate audio signal. Preferably, the multi-band noise 40 reduction may have the same frequency resolution as the second detection D2, and may be applied either on top of the frequency band-specific noise reduction (which is operating on the frequency bands FB1 of the first plurality), or may be implemented by setting a fixed value, preferably to be equal to the minimum value gnr-min, for the frequency band-specific noise reduction in all frequency bands FB1 of the first plurality (broadband second detection D2) or in all frequency bands FB1 of the first plurality that are comprised in or at least significantly overlapping with an m-th higher order frequency band FB2ₘ (see FIG. 2) of the second plurality (i.e., of the second detection D2). Note that in case of a multi-band noise reduction 40 being applied, the first attenuation relief bump 38 starting at approx. t=−5 s would not be showing; rather, the frequency band-specific noise reduction gain gnrk would equal its set minimum gnr-min at the low value Lo.

Preferably, when the second detection D2 detects no speech (nsp) after a phase (t-sp) of speech being present, i.e., when the second detection D2 detects a transition from a phase with speech (t-sp) being present to a phase (t-nsp) without speech, the multi-band noise reduction 40 is applied with a fast third time constant t3. The third time constant t3 may be in the order of the second time constant t2 used to fade the high value Hi for maximum attenuation to the low value Lo for maximum attenuation (i.e., minimum noise reduction gain gnr-min), or slightly larger. In FIG. 3, the third time constant t3 is chosen to be 4 s (starting at t=15 s).

In another advantageous embodiment, the characteristic parameter is given by a noise level and/or a useful signal level in the respective signal contributions of the intermediate audio signal in the corresponding frequency band. The characteristic parameter may be given, e.g., directly by a noise level in the frequency band. The noise level may be measured by taking a level measurement averaging the signal power in the frequency band over a first time window of a length between preferably 10 ms and 100 ms, and looking for the minimum of the level measurement over a second time window, the second time window preferably having a length of 0.1 s to 10 s and being most preferably at least one order of magnitude longer than the first window. The characteristic parameter may also be given by a proportion of the noise with respect to the overall signal in the frequency band.

It is then of further advantage to determine the frequency band-specific noise reduction gain as a Wiener gain in dependence on the noise level and/or the useful signal level. The Wiener gain may be determined, e.g., as

$${gnr}_{k} = 1 - \frac{\text{?}}{{S}_{x , k}}$$

wherein S_{x,k} denotes the instantaneous signal level in the k-th frequency band and [symbol] denotes the estimated noise level in the k-th frequency band.

In an alternative embodiment, the first detection detects the presence of stationary noise in respective signal contributions of the intermediate audio signal in the corresponding frequency band. This in particular comprises the case that, while other sorts of noise contributions may be possible, the first detection is specifically designed to detect the presence of stationary noise in the corresponding frequency band. A detection of stationary noise is typically easy to implement, as it does not require a complex distinction of sound patterns.

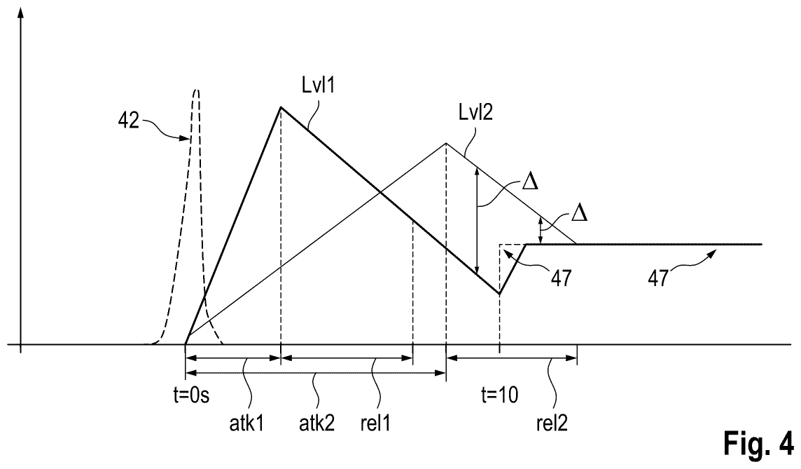

Expediently, the first detection detects the presence of stationary noise in the signal contributions by means of a first level meter and a second level meter being applied to the intermediate audio signal in the corresponding frequency band. This is shown in FIG. 4, which displays the outputs of a first level meter lvl1 and a second level meter lvl2 in a given (k-th) frequency band, plotted against the time t, while reacting to an impulse-like sound event 42 starting at t=0 s (dashed line), after total silence. In particular, those level meters lvl1, lvl2 may have different parametrizations regarding attack and/or release times and/or regarding overall sensitivity, so that differences in the level meters lvl1, lv12 allow for the detection of stationary noise in the corresponding frequency band. A level meter is very easy to implement, e.g., via (recursive) low-pass filters (which may be of 1^{st} order), and thus allows for an easy detection of stationary noise.

In particular, the first level meter lvl1 has a short first attack time atk1 and a long first release time rel1, wherein the second level meter lvl2 has a long second attack time atk2 (longer than the first attack time atk1) and a long second release time rel2 (which may be identical to the first release time rel1), and wherein the first detection D1ₖ detects the presence of stationary noise on the basis of a difference Δ of an output of the first level meter lvl1 and an output of the second level meter lvl2.

In FIG. 4, the second level meter lvl2, due to its second slower attack time atk2 and the resulting average over more silence time, shows a lower peak than the first level meter lvl1. The first and second release times rel1, rel2 are defined with respect to the output of the corresponding level meter lvl1, lv12 falling to half the level of the peak value. For better illustration, at t=10 s, a stationary noise signal 44 starts (dashed line), leading to corresponding contributions in the outputs of the level meters lvl1, lv12, and affecting the difference Δ of their outputs accordingly, converging to zero.

It is of further advantage setting the frequency band-specific noise reduction gain gnr (see FIGS. 2 and 3) in a quantitative and preferably monotonous dependence on the difference Δ of an output of the first level meter lvl1 and an output of the second level meter lvl2. This in particular comprises that the difference Δ of the output of the two level meters lvl1, lv12 is not only used to detect whether noise is present in a frequency band, but also as an input value x1=A to the above-mentioned function gnrk=F (x1, x2), wherein the function F preferably is monotonous in x1.

The following is a summary list of reference numerals and the corresponding structure used in the above description of the invention:
1 hearing device
2 hearing aid
3 earpiece
4 input transducer
5 environment sound
8 input signal
10 microphone
12 signal processing unit
14 intermediate audio signal
16 output signal
18 output transducer
20 output sound signal
22 loudspeaker
24 pre-processing
26 first filter bank
27 frequency band-specific noise reduction
28 auxiliary signal path
30 second filter bank
32 acoustic features
34 synthesis filter bank
36 noise-reduced broadband signal
37 broadband signal processing
38 attenuation relief bump
40 multi-band noise reduction
42 sound event
44 stationary noise signal
ANN artificial neural network
Atk1/2 first/second attack time
D1ₖ first detection (in k-th frequency band)
D2 second detection
FB1/2 frequency bands (of first/second plurality)
FB1ₖ (k-th) frequency band
FB2ₘ (m-th “higher order”) frequency band
gnr₍ₖ₎ noise reduction gain (in frequency band k)
gnr-min minimum noise reduction gain
Hi high value (for minimum noise reduction gain)
Lo low value (for minimum noise reduction gain)
Lvl1/2 first/second level meter output
nsp no presence of speech detected (by second detection)
rel1/2 first/second release time
sp presence of speech detected (by second detection)
t time
t1-t3 first to third time constant
t-nsp phase/time period without speech
t-sp phase/time period with speech
Δ difference (of first and second level meter output)

1. A method for noise suppression in a hearing device, the hearing device containing at least one acousto-electric input transducer configured to generate an electric input signal from an environment sound, the method comprises the steps of:
deriving an intermediate audio signal from the electrical input signal;
dividing the intermediate audio signal into a first plurality of frequency bands;
performing a frequency band-specific noise reduction on the intermediate audio signal for at least for some of the first plurality of frequency bands, the frequency band-specific noise reduction comprising the sub-steps of:
performing a first detection for determining a characteristic parameter related to a noise component and/or a useful signal component being present in respective signal contributions of the intermediate audio signal in a corresponding frequency band of the first plurality of frequency bands; and
applying a frequency band-specific noise reduction gain to the respective signal contributions of the intermediate audio signal in a respective frequency band of the first plurality of frequency bands in dependence on the first detection;
performing a second detection on the intermediate audio signal, the second detection configured to detect speech being present in the environment sound, and the second detection having a lower frequency resolution than the first plurality of frequency bands; and
setting a value of at least some of the frequency band-specific noise reduction gains in dependence on the speech detected in the second detection.

2. The method according to claim 1, which further comprises setting a maximum value and/or a minimum value of the frequency band-specific noise reduction gains in dependence on the speech detected in the second detection.

3. The method according to claim 2, which further comprises performing at least one of:
setting the minimum value of the frequency band-specific noise reduction gains to a low value for no said speech being detected by the second detection; or
setting the minimum value of the frequency band-specific noise reduction gains to a high value if said speech is detected as present during the second detection.

4. The method according to claim 3, wherein upon the second detection detecting a presence of the speech after a phase of no said speech, the minimum value to be set is faded with a first time constant from the low value to the high value.

5. The method according to claim 4, wherein upon the second detection detecting no said speech after a phase of the speech being present, the minimum value to be set is faded with a second time constant from the high value to the low value.

6. The method according to claim 1, wherein the characteristic parameter is given by a noise level and/or a useful signal level in the respective signal contributions of the intermediate audio signal in the corresponding frequency band.

7. The method according to claim 6, which further comprises determining the frequency band-specific noise reduction gain as a Wiener gain in dependence on the noise level and/or the useful signal level.

8. The method according to claim 1, wherein the first detection detects a presence of stationary noise in the respective signal contributions of the intermediate audio signal in the corresponding frequency band.

9. The method according to claim 8, wherein the first detection detects the presence of the stationary noise in the signal contributions by means of a first level meter and a second level meter being applied to the intermediate audio signal in the corresponding frequency band.

10. The method according to claim 9, wherein:
the first level meter has a short first attack time and a long first release time;
the second level meter has a long second attack time and a long second release time; and
the first detection detects the presence of the stationary noise on a basis of a difference of an output of the first level meter and an output of the second level meter.

11. The method according to claim 9, which further comprises:
setting the frequency band-specific noise reduction gain in dependence on a difference of an output of the first level meter and an output of the second level meter.

12. The method according to claim 1, which further comprises:
applying, upon the second detection detecting no said speech being present in the environment sound, a multi-band noise reduction to the intermediate audio signal.

13. The method according to claim 12, wherein, upon the second detection detecting no said speech after a phase of the speech being present, the multi-band noise reduction is applied with a fast third time constant.

14. The method according to claim 1, which further comprises:
dividing the intermediate audio signal into a second plurality of frequency bands, the second plurality of frequency bands being smaller than the first plurality of frequency bands; and
performing the second detection for detecting said speech being present in the environment sound to the respective signal contributions of the intermediate audio signal in a corresponding frequency band of the second plurality of frequency bands; or
performing the second detection on the broadband intermediate audio signal.

15. The method according to claim 1, wherein:
the second detection is performed by means of an artificial neural network; and
an output class of the artificial neural network indicates a presence of said speech.

16. The method according to claim 15, which further comprises:
generating a plurality of acoustic features on a basis of the electric input signal; and
using the acoustic features as input values to the artificial neural network, wherein the acoustic features are chosen out of a following set:
a spectral centroid of an overall signal and/or of a noise background, a modulation depth for at least one given modulation frequency, a signal stationarity, a signal level, a noise level for at least one given frequency range, and an auto-correlation value for at least one given time delay.

17. The method according to claim 5, wherein the second time constant is faster than the first time constant.

18. A hearing device, comprising:
at least one input transducer configured to generate an electric input signal from an environment sound; and
at least one signal processing unit configured to perform the method according to claim 1.
